(19) United States
(12) Patent Application Publication
(10) Pub. No.: US 2021/0402325 A1
(43) Pub. Date: Dec. 30, 2021

(54) CANNABINOID CRYSTALLIZATION METHODS AND SYSTEMS

(71) Applicants: JOHN NAITO, PORTLAND, OR (US); KYLER BUCK, PORTLAND, OR (US)

(72) Inventors: JOHN NAITO, PORTLAND, OR (US); KYLER BUCK, PORTLAND, OR (US)

(21) Appl. No.: 17/354,958

(22) Filed: Jun. 22, 2021

Related U.S. Application Data
(60) Provisional application No. 63/044,661, filed on Jun. 26, 2020.

(51) Int. Cl. B01D 11/02; B01D 9/00

(52) U.S. Cl. CPC B01D 11/0288; B01D 2009/0086; B01D 9/00; B01D 11/0207

(57) ABSTRACT

A method includes introducing a biomass and a solvent into an extraction vessel to form a mixture, controlling process conditions to increase extraction of target cannabinoids and decrease extraction of impurities, the process conditions including at least one of temperature, solvent composition, and agitation, moving the mixture from the extraction vessel to a separation vessel through a filtration system, balancing a solvent-solute ratio of the mixture as needed, crystallizing the target cannabinoids from the mixture in the separation vessel to produce cannabinoid crystals, separating a mother liquor out of the separation vessel, recovering any residual solvent, and removing the cannabinoid crystals from the vessel.

### RELATED APPLICATION

This disclosure claims benefit of and priority to U.S. Provisional Patent Application No. 63/044,661 titled “CBD CRYSTALLIZATION METHODS AND SYSTEMS,” filed Jun. 26, 2020, which is incorporated herein by reference in its entirety.

### BACKGROUND

Current methods for the extraction and purification of cannabinoids from biomass require many discrete separation processes using multiple solvents. In conventional techniques, a crude oil is extracted from biomass with concentrations of the target cannabinoid as low as 50%. Most fats and waxes are then separated from the crude oil, often through a winterization process. This process can include dissolution of the crude oil into a solvent, precipitation of the fats and waxes, separation of fats and waxes by filtration or decanting, and separation of the solvent by simple distillation. The concentration of target cannabinoids can be as high as 80% in this partially refined oil.

Next, more impurities are removed, often by fractional distillation. The resulting distillate product, with target cannabinoid concentrations between 80% and 98%, must then be processed through one more refinement technique.

In the final purification process, the refined oil (80%-98% purity), is dissolved in a solvent, which is typically different from the extraction and winterization solvents. The target cannabinoid is then precipitated from the solution using any one of several crystallization methods. The high purity precipitate is then removed from the solution and dried.

Such multi-stage processes are slow, labor intensive, and offer many opportunities for losses of the target cannabinoid product and also wasting other valuable compounds including secondary cannabinoids and terpenes.

There remains a need for improved extraction and purification processes for cannabinoids.

### BRIEF DESCRIPTION OF THE DRAWINGS

FIG. 1 illustrates a cutout view of an example of a system for crystallizing CBD in accordance with the disclosed technology.

FIG. 2 illustrates a cutout view of an example of a system for crystallizing CBD in accordance with the disclosed technology.

### DETAILED DESCRIPTION

The embodiments here generally involve the extraction and purification of cannabinoids by crystallization using a hydrocarbon solvent. A hydrocarbon solvent extraction may achieve a high enough purity in the solution of crude oil and extraction solvent to create a supersaturation of the target cannabinoid. The target cannabinoid may then undergo crystallization in the extract solution, and then decanting, filtering, centrifuging, or other separation from the mother liquor using suitable techniques. The embodiments here address cannabidiol (CBD), but could also apply to cannabidiol acid (CBDA), cannabigerol (CBG), cannabinol (CBN), tetrahydrocannabinol (THC), tetrahydrocannabinol acid (THCA) etc., and their variations

The various advantages provided by the embodiments include, without limitation: simplified extraction and purification of cannabinoids from plant biomass; reduced production time for high purity cannabinoids; lowered product losses from transfers between processes; and opportunity to preserve valuable secondary compounds normally lost during extraction and purification.

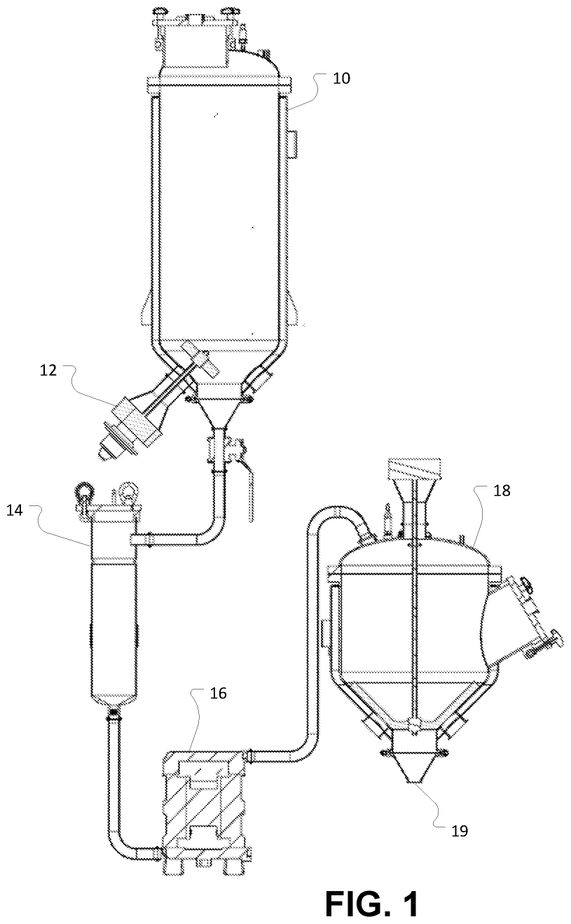

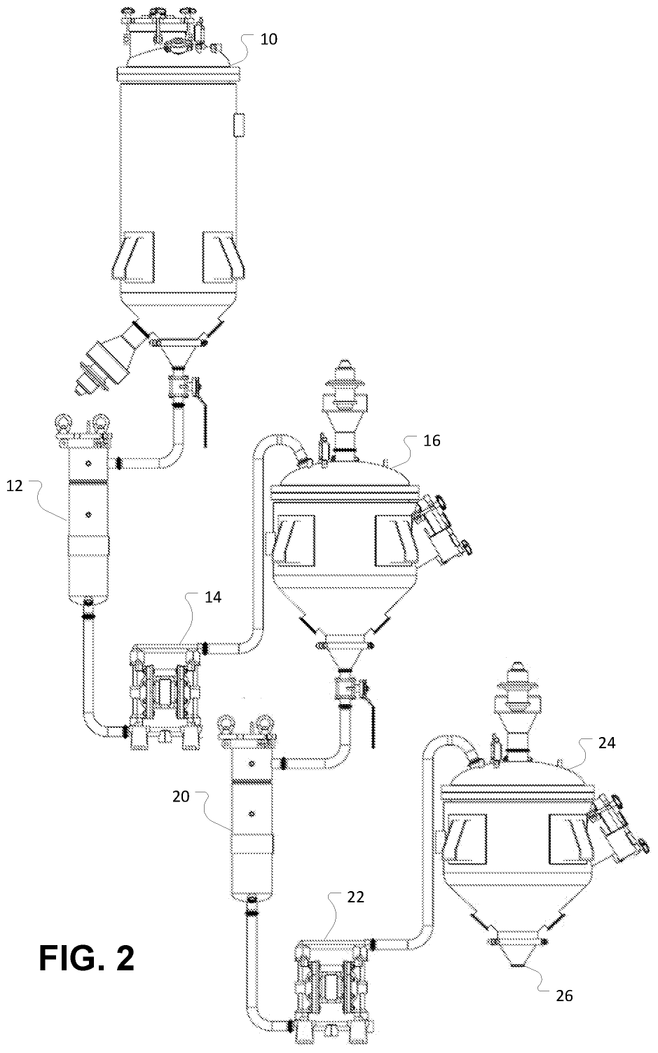

An embodiment involves a method that may include introducing a biomass of cannabis vegetation and a solvent into an extraction vessel. FIG. 1 shows an example of a system having an extraction vessel 10, a filtration system 14 and a separation vessel 18. The term “extraction vessel” as used here means the vessel in the process that receives the biomass and the solvent, referred to here as the “mixture.” Similarly, the term “separation vessel” means a vessel to which the mother liquor or residual liquid is moved. In one embodiment, shown in FIG. 1, the mother liquor is removed from the separating vessel after the mixture moves from the extraction vessel through a filtering system. The term “mother liquor” means the solvent and target cannabinoid solution that remains after the crystals have been removed after crystallization. The term “residual solvent” refers to any liquid, whether having washing solvent added or not, that remains after the mother liquor is removed. In another embodiment, shown in FIG. 2, the process may employ a second filtration system 20, and a second separation vessel 24, discussed in more detail below.

Returning to FIG. 1, the biomass, typically cannabis plant matter and a solvent are combined into the extraction vessel 10. The extraction vessel may have controllable process conditions including the solvent composition, temperature and agitation. Controlling the process conditions may increase the extraction of target compounds and decrease the extraction of impurities. The control of process conditions may differ between the extraction vessel and the separation vessel.

In one embodiment, the solvent may comprise a hydrocarbon solvent. Hydrocarbon solvents include, but are not limited to, propane, hexane, heptane, and butane. Some hydrocarbon solvents have high toxicity, making them inappropriate for use in extraction. In one embodiment, the solvent is propane. Others in the industry use butane, or more typically, a mix of butane with other solvents including propane. To differentiate the solvent used initially with the biomass from the washing solvent, the solvent at this part of the process will be referred to as the biomass solvent.

The extraction vessel may include an agitation means 12 to mix or stir the biomass and solvent mixture. The agitation means may comprise a paddle wheel agitator, nitrogen bubbles moving through the mixture, or solvent vapor through the mixture with the aid of a pump not shown. In one embodiment, the system uses a paddle wheel agitator to stir the biomass and solvent mixture. The control of the speed and/or force of the mixing affects the chemical composition of the mixture. In general, more agitation creates a higher cannabinoid concentration, which in turn aids in crystallization. Too much agitation may increase the concentration of the impurities in the mixture, which would negatively affect the crystallization

In the extraction vessel, temperature has a similar effect as agitation. Higher temperatures generally leads to more impurities but faster extraction, a negative effect on crystallization. Lower temperatures generally lead to fewer impurities but slower extraction, a positive effect on crystallization. The embodiment here generally cool the solution to below ambient. For example, the vessel may be cooled to a temperature in the range of −10° C. to −40° C.

Once the biomass and solvent are sufficiently mixed, some embodiments move the mixture from the extraction vessel to a separation vessel through a filtration system using a pump 14. The filtration system may include any or all of the following: large mesh size dead-end filters to separate the biomass; small mesh size dead-end filters to separate impurities such as fats, waxes, and small biomass particles; tangential flow membrane filters; and filtration media, such as bentonite clay, activated carbon, or magnesium silicate for decolorization,

In certain implementations, the embodiments include repeating any or all of the previous steps to reach a desired extraction yield, for example.

Once the mixture of biomass and solvent reach the separation vessel, the process may include balancing the solvent-solute ratio. The process may add or remove solvent from or to the solution in the separation vessel if the solvent-solute ratio from the extraction does not meet necessary conditions for crystallization. Removal of the solvent may involve distillation, for example. If the ratio is already balanced, the process will just continue.

After balancing the solute-solvent ratio, the process crystallizes the target compound from the solution by one or a combination of processes to create supersaturation of the target compound. These processes may involve cooling by lowering the temperature of the solution in the separation vessel, evaporation by boiling the solution in the separation vessel, and anti-solvent crystallization by introducing an anti-solvent into the solution. An anti-solvent generally consists of a compound in which the solute is less soluble than in the solvent. Examples of anti-solvents may include water, methanol and glycerol, as examples.

In some embodiments, once the solute-solvent ratio reaches the proper balance, the process may move the balanced mixture to a second separation vessel such as 24 of FIG. 2, with the aid of a second pump 22, or a connection to the first pump 14. This may also involve a second filtration system 20. The crystallization would then occur in the second separation vessel 24. One should note that the second separation vessel, as well as any particular configuration of elements, etc., are optional. The embodiments here encompass the method of the extraction, the equipment used may take the form of any components or connections that can enable the method of extraction.

Generally, the mother liquor will be drained or otherwise removed from a separation vessel after crystallization. The embodiments may further include draining, or decanting, the mother liquor out of the separation vessel through a port 19 of FIG. 1 that may include a filter so that the crystallized cannabinoid remains in the vessel. If a second separation vessel is used as in FIG. 2, the mother liquor may be drained there, such as through port 26. The process may use alternative techniques to remove the mother liquor, including decanting, centrifuge, or other suitable technique.

In certain implementations, where impurities may remain in the separation vessel after draining the mother liquor, a washing process may be used to flush the impurities out of the vessel. While it will be appreciated that any suitable solvent may wash the crystals, one embodiment uses the same single hydrocarbon solvent used as the biomass solvent. Process conditions and solvent for the wash may be selected such that the impurities re-dissolve into the solvent but the crystallized compound does not. A “single” hydrocarbon solvent means a hydrocarbon solvent of only one hydrocarbon, such as butane, propane, etc., instead of a blend of solvents. For example, many current processes use a blend of butane and propane.

In such implementations, the washing solvent may be introduced into the separation vessel. This may take the form of allowing the washing solvent to flow through the crystallized cannabinoids and impurities and out of the vessel in a continuous process, fill the vessel to a desired fluid level, allow it stand with or without agitation until the impurities are dissolved, and then drain the residual solution in a batch process.

One embodiment recovers the residual solvent after the process has removed the mother liquor from the crystallized cannabinoid, by adding heat and/or vacuuming, for example. Similarly, the residual solvent and/or the mother liquor could undergo further processing to crystallize or otherwise isolate other useful compounds from them. Alternatively, either or both could be discarded.

Once the process has completed, the process may remove the crystallized cannabinoid from the vessel.

In certain implementations, any or all of the embodiments described above may be performed in a continuous process.

Another advantage of the embodiments lies in the use of a single solvent. In one embodiment the same hydrocarbon solvent is the biomass solvent and the washing solvent. In one embodiment, the same hydrocarbon solvent comprises a single hydrocarbon, such as butane or propane only, not mixed with any other hydrocarbon solvents.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated.

Consequently, in view of the wide variety of permutations to the embodiments that are described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A method, comprising:
introducing a biomass and a biomass solvent into an extraction vessel to form a mixture;
controlling process conditions to increase extraction of target cannabinoids and decrease extraction of impurities, the process conditions including at least one of temperature, solvent composition, and agitation;
moving the mixture from the extraction vessel to a separation vessel through a filtration system;
balancing a solvent-solute ratio of the mixture as needed;
crystallizing the target cannabinoids from the mixture in the separation vessel to produce cannabinoid crystals;
separating a mother liquor out of the separation vessel;
recovering the remaining solvent; and
removing the cannabinoid crystals from the vessel.

2. The method of claim 1, wherein the filtration system includes at least one selected from large mesh size dead-end filters, small mesh size dead-end filters having a mesh size smaller than the large mesh size dead-end filters, tangential flow membrane filters, and filtration media, comprising at least one of bentonite clay, activated carbon, or magnesium silicate.

3. The method of claim 1, further comprising repeating the introducing, providing, and moving to reach a desired extraction yield for the target cannabinoids.

4. The method of claim 1, wherein balancing the solvent-solute ratio comprises adding solvent to the solution in the separation vessel if the solvent-solute ratio from the extraction does not meet necessary conditions for crystallization.

5. The method of claim 1, wherein balancing the solvent-solute ration comprises removing solvent from the solution in the separation vessel if the solvent-solute ratio from the extraction does not meet necessary conditions for crystallization.

6. The method of claim 5, wherein removing solvent from the solution includes a distillation process.

7. The method of claim 1, further comprising moving the solution to a second separation vessel for crystallization after balancing the solute-solvent ratio.

8. The method of claim 1, wherein the crystallizing includes at least one of lowering the temperature of the solution in the separation vessel to create supersaturation, boiling the solution in the separation vessel to create supersaturation, and introducing an anti-solvent into the solution to create supersaturation.

9. The method of claim 1, wherein the separating includes decanting.

10. The method of claim 9, wherein the decanting includes using a filter to leave the target compound in the vessel.

11. The method of claim 1, wherein the separating includes centrifuging.

12. The method of claim 1, further comprising washing the cannabinoid crystals with a washing solvent to flush impurities out of the vessel.

13. The method of claim 12, wherein the washing further comprises using a same washing solvent to wash the cannabinoid crystals as the biomass solvent.

14. The method of claim 12, wherein process conditions and the washing solvent should be selected such that the impurities re-dissolve into the solvent but the cannabinoid crystals do not.

15. The method of claim 12, wherein the washing comprises:
introducing the washing solvent into the separation vessel; and
allowing the washing solvent to flow through the cannabinoid crystals and impurities and out of the vessel in a continuous process.

16. The method of claim 12, wherein the washing comprises:
introducing the washing solvent into the separation vessel;
filling the vessel to desired fluid level to produce a residual solvent
allowing the vessel to stand with or without agitation until the impurities are dissolved; and
draining the residual solvent in a batch process.

17. The method of claim 1, further comprising separating other valuable compounds from the mother liquor.

18. The method of claim 1, wherein introducing the biomass and the biomass solvent comprises introducing the biomass and a single hydrocarbon solvent.

19. The method of claim 1, wherein the biomass solvent and the washing solvent are a same solvent.
